(19) United States
(12) Patent Application Publication
(10) Pub. No.: US 2021/0168559 A1
(43) Pub. Date: Jun. 3, 2021

(54) METHOD AND APPARATUS FOR PROVIDING NAVIGATION SERVICE BY USING BLUETOOTH LOW ENERGY TECHNOLOGY

(71) Applicant: LG ELECTRONICS INC., Seoul (KR)

(72) Inventors: Jinkwon LIM, Seoul (KR); Taeyoung SONG, Seoul (KR)

(73) Assignee: LG ELECTRONICS INC., Seoul (KR)

(21) Appl. No.: 16/633,941

(22) PCT Filed: Jul. 25, 2018
(86) PCT No.: PCT/KR2018/008433

§ 371 Date: Jan. 24, 2020

Related U.S. Application Data
(60) Provisional application No. 62/536,923, filed on Jul. 25, 2017.

(51) Int. Cl. H04W 4/024; H04W 4/80; H04W 4/029; G01S 19/11; G01S 19/34

(52) U.S. Cl. CPC H04W 4/024; H04W 4/80; G01S 19/34; G01S 19/11; H04W 4/029

(57) ABSTRACT

The present invention relates to a method and apparatus for setting a path by a terminal together with a navigation device in a wireless communication system. The present invention provides a method and apparatus for: acquiring, from a user, destination information indicating a destination; setting a path to the destination on the basis of the destination information; establishing a connection with the navigation device through Bluetooth low energy (LE); receiving, from the navigation device, a request message requesting global positioning system (GPS) information for providing a navigation service on the basis of the set path; and transmitting a response message including the GPS information to the navigation device.

### TECHNICAL FIELD

The present disclosure relates to a method and apparatus for providing a navigation service using Bluetooth, that is, a short-distance communication technology, in a wireless communication system and, more particularly, to a method and apparatus for transmitting and receiving, by a terminal and a navigation device, global positioning system (GPS) information using a Bluetooth low energy (BLE) technology.

### BACKGROUND ART

Bluetooth is a short-range wireless technology standard that may wirelessly connect various types of devices and allows them to exchange data over short distances. To enable wireless communication between two devices using Bluetooth communication, a user has to perform the process of discovering Bluetooth devices to communicate with and making a connection request. As used herein, the term “device” refers to an appliance or equipment.

In this case, the user may discover a Bluetooth device according to a Bluetooth communication method intended to be used using the Bluetooth device, and subsequently perform a connection.

The Bluetooth communication method may be divided into a BR/EDR method and an LE method. The BR/EDR method may be called Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other using an attribute protocol. The Bluetooth LE method can reduce energy consumption by reducing overhead of a header and simplifying an operation.

Among the Bluetooth devices, some products do not have a display or a user interface. The complexity of a connection, management, control, and disconnection among various types of Bluetooth devices and Bluetooth device using similar technologies has increased.

Bluetooth supports a high speed at relatively low power consumption and at a relatively low cost. However, Bluetooth is appropriately used within a limited space because a transmission distance of Bluetooth is a maximum of 100 m.

### DISCLOSURE

### Technical Problem

The disclosure provides a method for transmitting and receiving data in order to provide a navigation service between a terminal and a navigation device in a wireless communication system.

Furthermore, the disclosure provides a method for providing, to a navigation device, global positioning system (GPS) information indicating a route set through a terminal.

Furthermore, the disclosure provides a method for obtaining, by a navigation device, GPS information from a terminal and providing a navigation service.

Furthermore, the disclosure provides a method for periodically transmitting and receiving, by a terminal and a navigation device, updated GPS information when the GPS information is updated.

Furthermore, the disclosure provides a method for notifying an occurred specific event when the specific event occurs while a navigation service is provided.

Technical objects to be achieved in the disclosure are not limited to the aforementioned technical objects, and other technical objects not described above may be evidently understood by a person having ordinary skill in the art to which the disclosure pertains from the following description.

### Technical Solution

There is provided a method of setting, by a terminal, a route along with a navigation device in a wireless communication system.

Specifically, according to an embodiment of the disclosure, a method of setting, by a terminal, a route along with a navigation device in a wireless communication system includes obtaining, from a user, destination information indicating a destination, setting a route to the destination based on the destination information, forming a connection with the navigation device through Bluetooth low energy (LE), receiving, from the navigation device, a request message to request global positioning system (GPS) information for providing a navigation service based on the set route, and transmitting, to the navigation device, a response message comprising the GPS information.

Furthermore, in the disclosure, the GPS information includes at least one of route information indicating a travel route to the destination, track information indicating a moved route of the user or way point information indicating a waypoint between routes from a source to the destination, and the format of the GPS information is a GPS exchange format (GPX).

Furthermore, the disclosure further includes receiving, from the navigation device, an update request message to request GPS information changed in a specific cycle, and transmitting, to the navigation device, an update response message including the changed GPS information if the GPS information is changed.

Furthermore, the disclosure further includes forming a connection with a wearable device through Bluetooth low energy (LE), and transmitting a notification message for the notification of a specific event to at least one of the wearable device or the navigation device when the specific event occurs while providing the navigation service.

Furthermore, the disclosure further includes obtaining, from the wearable device, state information indicating a body state of the user, and transmitting, to at least one of the wearable device or the navigation device, an indication message indicating a specific operation based on the body state.

Furthermore, the disclosure further including performing an initial update procedure for providing the navigation service along with the navigation device.

Furthermore, in the disclosure, the initial update procedure includes receiving an update request message to request an update of map information for providing the navigation service and transmitting an update response message including the updated map information if the map information is updated.

Furthermore, in the disclosure, the initial update procedure further includes performing an operation for providing a specific service configured to be executed along with the navigation service.

Furthermore, the disclosure provides a terminal for setting a route along with a navigation device in a wireless communication system, including a communication unit for performing wireless or wired communication with an outside and a processor functionally connected to the communication unit. The processor is configured to obtain, from a user, destination information indicating a destination, set a route to the destination based on the destination information, form a connection with the navigation device through Bluetooth low energy (LE), receive, from the navigation device, a request message to request global positioning system (GPS) information for providing a navigation service based on the set route, and transmit, to the navigation device, a response message including the GPS information.

### Advantageous Effects

According to the disclosure, a navigation device can periodically obtain updated GPS information from a terminal and provide updated route information in real time.

Furthermore, according to the disclosure, information of an updated navigation application can be obtained from a terminal without a separate update procedure, and the navigation application can be updated.

Furthermore, according to the disclosure, there is an effect in that if a specific event occurs during driving, a user can easily recognize the occurred specific event.

Effects which may be obtained in the disclosure are not limited to the aforementioned effects, and other technical effects not described above may be evidently understood by a person having ordinary skill in the art to which the disclosure pertains from the following description.

### DESCRIPTION OF DRAWINGS

FIG. 1 is a schematic diagram illustrating an example of a wireless communication system using a Bluetooth low energy technology to which the disclosure is applied.

FIG. 2 shows an example of an internal block diagram of a device capable of implementing methods proposed in the disclosure.

FIG. 3 shows an example of Bluetooth low energy architecture to which the disclosure is applied.

FIG. 4 shows an example of a data format used in an ATT Protocol to which the disclosure is applied.

FIG. 5 shows an example of a method of providing an object transfer service in a Bluetooth low energy technology to which the disclosure is applied.

FIG. 6 shows an example of a navigation system.

FIG. 7 shows an example of a navigation service proposed in the disclosure.

FIG. 8 shows an example of the architecture of a profile proposed in the disclosure.

FIG. 9 shows an example of a packet format for providing a navigation service proposed in the disclosure.

FIGS. 10 and 11 show examples of a method for providing a navigation service, which is proposed in the disclosure.

FIG. 12 shows an example of an initial setting method for providing a navigation service, which is proposed in the disclosure.

FIG. 13 shows another example of a method for providing a navigation service, which is proposed in the disclosure.

FIG. 14 shows another example of a method for providing a navigation service, which is proposed in the disclosure.

FIG. 15 shows another example of a method for providing a navigation service, which is proposed in the disclosure.

FIG. 16 is a flowchart illustrating an example of a method for providing a navigation service, which is proposed in the disclosure.

### MODE FOR INVENTION

The aforementioned objects, features and advantages of the disclosure will become more apparent through the following detailed description with respect to the accompanying drawings. Hereinafter, the embodiments of the disclosure will be described with reference to the accompanying drawings, in which like numbers refer to like elements throughout the specification. In describing the disclosure, a detailed description of known techniques associated with the disclosure unnecessarily obscure the gist of the disclosure, it is determined that the detailed description thereof will be omitted.

Hereinafter, a terminal related to the disclosure will be described in detail with reference to the accompanying drawings. In the following description, the usage of suffixes, such as a “module”, a “part” or a “unit” used to refer to an element, is merely given to facilitate the description of the disclosure, without having any significant meaning by itself.

As used herein, a “message” may also be called a data packet, a frame, or a PDU.

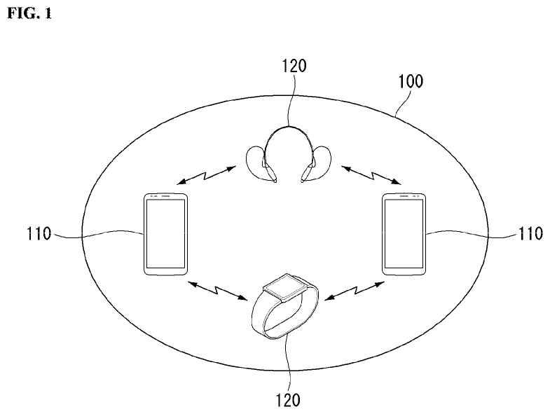

FIG. 1 is a view schematically illustrating an example wireless communication system using Bluetooth low power energy technology to which the disclosure is applicable.

A wireless communication system 100 includes at least one server device 120 and at least one client device 110.

The server device and the client device perform Bluetooth communication using the Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may also be referred to as a data service device, slave device, slave, server, conductor, host device, gateway, sensing device, monitoring device, second device, or audio gate (AG), and the client device 110 may also be referred to as a master device, master, client, member, sensor device, sink device, collector, first device, or hands-free device.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Also, in order to provide data information to the client device, the server device sends a notification message or an indication message to the client device in order to provide data information to the client device. Also, the server device receives a confirmation message corresponding to the indication message from the client device.

Also, in the process of transmitting and receiving notification, indication, and confirmation messages to and from the client device, the server device may provide data information to a user through a display unit or may receive a request input from the user through a user input interface.

Also, in the process of transmitting and receiving message to and from the client device, the server device may read data from a memory unit or may write new data to the corresponding memory unit.

Also, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Also, in the process of transmitting and receiving messages with the server device, the client device may read data from a memory unit or may write new data to the corresponding memory unit.

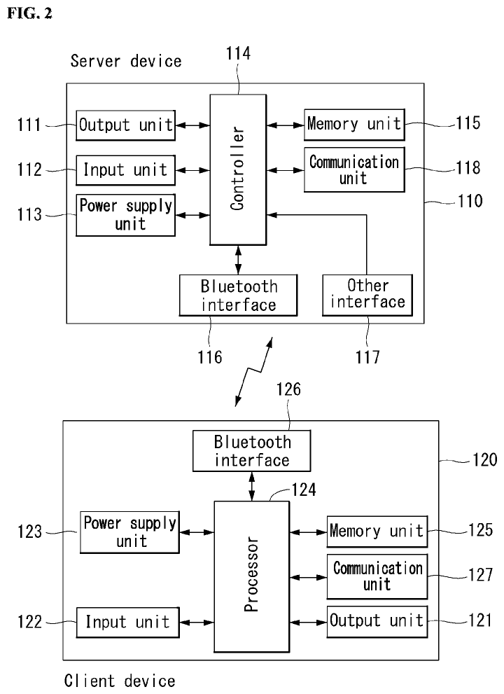

Hardware components such as the display units, the user input interfaces, and the memory units of the server device and the client device will be described in detail with reference to FIG. 2.

Also, the wireless communication system may configure personal area networking (PAN) through the Bluetooth technology. For example, in the wireless communication system, a private piconet may be established between devices to quickly and safely exchange files, documents, and the like.

FIG. 2 shows an example of an internal block diagram of a device capable of implementing methods proposed in the disclosure.

As illustrated in FIG. 2, a server device includes a display unit 111, a user input interface 112, a power supply unit 113, a processor 114, a memory unit 115, a Bluetooth interface 116, other interface 117, and a communication unit (or transceiver unit) 118.

The display unit 111, the user input interface 112, the power supply unit 113, the processor 114, the memory unit 115, the Bluetooth interface 116, other interface 117, and the communication unit 118 are functionally connected to each other to perform a method proposed in this disclosure.

Also, the client device includes a display unit 121, a user input interface 122, a power supply unit 123, a processor 124, a memory unit 125, a Bluetooth interface 126, and a communication unit (or transceiver unit) 128.

The display unit 121, the user input interface 122, the power supply unit 123, the processor 124, the memory unit 125, the Bluetooth interface 126, other interface 127, and the communication unit 128 are functionally connected to each other to perform a method proposed in this disclosure.

The Bluetooth interfaces 116 and 126 refer to units (or modules) able to transmit data such as a request/a response, a command, a notification, an indication/confirmation message between devices.

The memory units 115 and 126 are units implemented in various types of devices, in which various types of data are stored.

The processors 114 and 124 refer to modules controlling a general operation of the server device or the client device, which control requesting transmission of a message through the Bluetooth interface and other interface and processing a received message therethrough.

The processors 114 and 124 may also be called a controller, a control unit, and the like.

The processors 114 and 124 may include an application-specific integrated circuit (ASIC), other chip set, a logic circuit and/or data processing unit.

The processors 114 and 124 control the communication units to receive an advertising message from the server device, control the communication unit to transmit a scan request message to the server device and receive a scan response message as a response to the scan request from the server device, and control the communication unit to transmit a connection request message to the server device in order to establish a Bluetooth connection with the server device.

Also, after the Bluetooth LE connection is established through the connection procedure, the processors 114 and 124 control the communication units to read or write data by using an attribute protocol from the server device.

The memory units 115 and 125 may include a read-only memory (ROM), a random access memory (RAM), a flash memory, a memory card, a storage medium and/or other storage device.

The communication units 118 and 127 may include a baseband circuit for processing a wireless signal. When an embodiment is implemented by software, the aforementioned technique may be implemented as a module (process, function, etc.) performing the aforementioned function. The module may be stored in a memory unit and may be executed by a processor.

The memory units 115 may be present within or outside of the processors 114 and 124, and may be connected to the processors 114 and 124 through various well-known units.

The display units 111 and 121 refer to modules providing status information of the devices, message exchange information, and the like, to the user through a screen.

The power supply units 113 and 123 refer to modules receiving external power or internal power and supplying power required for operations of the respective components under the control of the controllers 114 and 124.

As described above, BLE technology uses a small duty cycle and capable of reducing power consumption considerably through low data transmission rate, by which the power supply unit can provide power required to operate individual elements even with small output power (less than 10 mw (10 dBm)).

The user input interfaces 112 and 122 refer to modules that provide a user input, such as a screen button, to the controllers to enable a user to control operations of the devices.

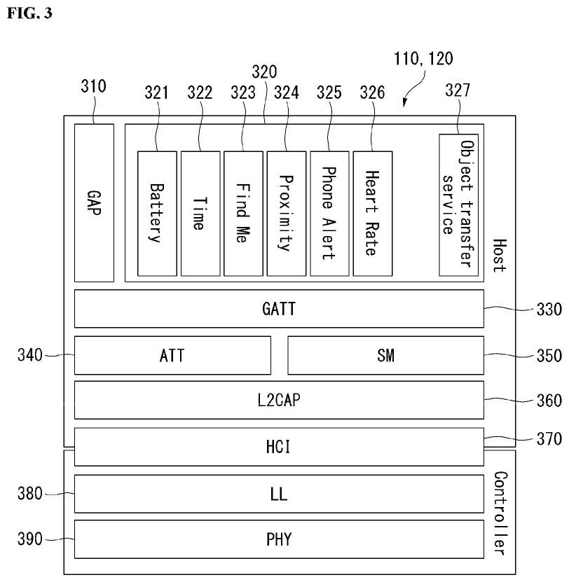

FIG. 3 shows an example of Bluetooth low energy architecture to which the disclosure is applied.

As illustrated in FIG. 3, the BLE architecture includes a controller stack capable of operating to process a wireless device interface whose timing is important and a host stack capable of operating to process high-level data.

The controller stack may be called a controller, but is hereinafter represented as a controller stack in order to avoid confusion with the processor, that is, an internal element of the device described in FIG. 2.

First, the controller stack may be implemented using a communication module which may include a Bluetooth wireless device and a processor module which may include a processing device, for example, a microprocessor.

The host stack is part of an OS operating on the processor module, and may be implemented as the instantiation of a package on the OS.

In some cases, the controller stack and the host stack may be driven or executed on the same processing device within the processor module.

The host stack includes a Generic Access Profile (GAP) 310, GATT based Profiles 320, a Generic Attribute Profile (GATT) 330, an Attribute Protocol (ATT) 340, a Security Manager (SM) 350, and a Logical Link Control and Adaptation Protocol (L2CAP) 360. In this case, the host stack is not limited thereto, and may include various protocols and profiles.

The host stack multiplexes various protocols, profiles, etc. provided by a high rank of Bluetooth using the L2CAP.

First, the Logical Link Control and Adaptation Protocol (L2CAP) 360 provides, to a specific protocol or profile, one bi-directional channel for transmitting data.

The L2CAP may operate to multiplex data between high layer protocols, segment and reassemble packages, and manage multicast data transmission.

In BLE, three fixed channels (one for a signaling CH, one for the Security Manager, and one for the Attribute protocol) are used.

In contrast, the Basic Rate/Enhanced Data Rate (BR/EDR) uses a dynamic channel and supports a protocol service multiplexer, retransmission, a streaming mode, etc.

The Security Manager (SM) 350 is a protocol for authenticating a device and providing a key distribution.

The Attribute Protocol (ATT) 340 defines a rule for accessing the data of a peer device in a server-client structure. The ATT includes 6 message types (Request, Response, Command, Notification, Indication, Confirmation).

That is, □ Request and Response message: the Request message is a message for requesting, by a client device, specific information from a server device. The Response message is a response message for the Request message and refers to a message transmitted from the server device to the client device.
Command message: a message transmitted to indicate the command of a specific operation from a client device to a server device. The server device does not transmit a response to a Command message to the client device.
Notification message: a message transmitted for notification, such as an event, from a server device to a client device. The client device does not transmit a Confirm message for a Notification message to the server device.
Indication and Confirm message: a message transmitted for notification, such as an event, from a server device to a client device. Unlike in the Notification message, the client device transmits a Confirm message for an Indication message to the server device.

The Generic Access Profile (GAP) is a layer newly implemented for the BLE technology, and is used to control the selection of a role for communication between BLE devices and how a multi-profile operation occurs.

Furthermore, the GAP is chiefly used for a device discovery, connection generation and security procedure part, defines a scheme for providing information to a user, and defines the type of attributes described below.
Service: define a basic operation of a device through a combination of behaviors related to data
Include: define a relation between services
Characteristics: a data value used in a service
Behavior: a computer-readable format defined as a Universal Unique Identifier (UUID), value type

The GATT-based Profiles are profiles having dependence on the GATT and are chiefly applied to a BLE device. The GATT-based Profiles may be a Battery, Time, FindMe, Proximity, Time, Object Delivery Service, etc. Detailed contents of the GATT-based Profiles are as follows.

Battery: a battery information exchange method

Time: a time information exchange method

FindMe: Provide an alarm service according to the distance

Proximity: a battery information exchange method

Time: a time information exchange method

The GATT may operate as a protocol to describe how the ATT operates when services are configured. For example, the GATT may operate to define how ATT attributes are grouped as services, and may operate to describe features related to services.

Accordingly, the GATT and the ATT may use features in order to describe the state and services of a device and describe how the features are related and how the features are used.

The controller stack includes a physical layer 390, a link layer 380 and a host controller interface 370.

The physical layer (wireless transmission and reception module) 390 is a layer that transmits and receives 2.4 GHz radio signals, and uses a Gaussian Frequency Shift Keying (GFSK) modulation and a frequency hopping scheme configured with 40 RF channels.

The link layer 380 transmits or receives a Bluetooth packet.

Furthermore, the link layer generates a connection between devices after performing Advertising, Scanning function using three Advertising channels, and provides a function for exchanging a data packet having a maximum of 42 bytes through 37 Data channels.

The Host Controller Interface (HCI) provides an interface between the host stack and the controller stack so that the host stack provides a command and Data to the controller stack and the controller stack provides an event and Data to the host stack.

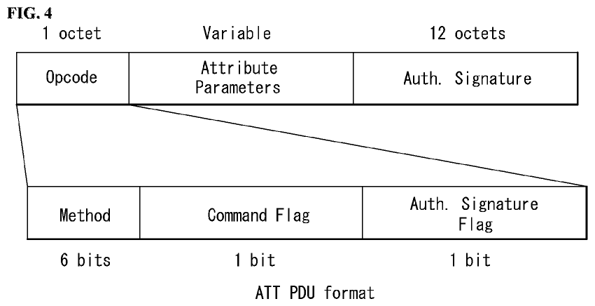

FIG. 4 shows an example of a data format used in an ATT Protocol to which the disclosure is applied.

The ATT Protocol defines a method of discovering, writing, and reading, by a device, the attributes of another device. In the ATT Protocol, the following two roles may be defined.
Attribute Server: exposes, to a peer device, attributes and a value related to the attributes.
Attribute Client: can discover, write and read the attributes of the server. In addition, the attribute client may be indicated and notified by the server.

As illustrated in FIG. 4, the format of a data packet used in the ATT Protocol may be configured with Opcode, Attribute Parameters, and Auth. Signature.

Opcode may be configured with Method, Command Flag and Auth. Signature Flag.

Each of the fields may be defined as follows.
Command Flag: the Command Flag indicates whether a corresponding PDU is a Command. There is no acknowledgement from a server for a Command.
Auth. Signature Flag: when a corresponding value is ‘1’, a value of the Authentication Signature is present.
Authentication Signature: the corresponding field is an optional field. If the corresponding field is present, a signature for the Opcode and Attribute fields are provided.

Hereinafter, procedures in the Bluetooth low energy (BLE) technology are described in brief.

The BLE procedure includes a device filtering procedure, an advertising procedure, a scanning procedure, a discovering procedure, a connecting procedure, etc.

Device Filtering Procedure

The device filtering procedure is a method for reducing the number of devices that perform a response to a request, indication, or notification in the controller stack. All devices do not need to respond when they receive a request. Accordingly, power consumption may be controlled to be reduced in the BLE controller stack by reducing the number of devices that transmit requests in the controller stack.

An advertising device or a scanning device may perform the device filtering procedure in order to limit devices that receive an advertising packet, a scan request or a connection request.

In this case, the advertising device refers to a device that transmits an advertising event, that is, performs advertising, and is also represented as an advertiser.

The scanning device refers to a device that performs scanning, a device that transmits a scan request.

In BLE, if some of advertising packets received by a scanning device are received from an advertising device, the scanning device needs to transmit a scan request to the advertising device. If a device filtering procedure is used and thus an advertising device to which a scan request needs to be transmitted is previously filtered, the scanning device may neglect advertising packets transmitted by the advertising device.

The device filtering procedure may also be used in a connection request process. If a device that makes a connection request does not use a preliminary device filtering procedure for a device that responds to the connection request, the device that has received the connection request (e.g., an advertising device that has performed advertising) needs to respond to the connection request.

A device that makes a connection request may be represented as an initiating device or an initiator.

An advertising device may use a device filtering procedure in order to limit devices that transmit a scan request or a connection request to the advertising device.

Advertising Procedure

An advertising device performs an advertising procedure in order to perform a non-directional broadcast on devices within an area. In this case, the non-directional broadcast refers to a broadcast to all directions not a broadcast to a specific direction. In contrast, a directional broadcast refers to a broadcast to a specific direction. The non-directional broadcast occurs without a connecting procedure between an advertising device and a device in a listening (or hearing) state (hereinafter called a listening device). An advertising procedure is used to establish a Bluetooth connection with a nearby initiating device. Alternatively, the advertising procedure may be used to provide the periodic broadcast of user data to scanning devices that perform listening in an advertising channel. In the advertising procedure, all advertisings (or advertising events) are broadcasted through an advertising physical channel.

A BLE device connected to a BLE piconet may perform advertising using a specific type of an advertising event.

Advertising devices may receive a scan request from listening devices that perform listening in order to obtain additional user data from an advertising device. The advertising device transmit a response to a scan request to a device that has transmitted the scan request through the same advertising physical channel as an advertising physical channel through which the scan request has been received. Broadcast user data that is transmitted using some of advertising packets is dynamic data, whereas scan response data is commonly static data.

An advertising device may receive a connection request from an initiating device on an advertising (broadcast) physical channel. If the advertising device has used a connectable advertising event and the initiating device has not been filtered by a device filtering procedure, the advertising device stops advertising and enters a connected mode. The advertising device may start the advertising after the connected mode.

Scanning Procedure

A device that performs scanning, that is, a scanning device, performs a scanning procedure in order to listen to the non-directional broadcast of user data from advertising devices that use an advertising physical channel in a scanning mode (ScanningMode).

A scanning device transmits a scan request to an advertising device in order to request additional user data from the advertising device through an advertising physical channel. The advertising device transmits a scan response, that is, a response to the scan request, including the additional user data requested by the scanning device through the advertising physical channel.

A scanning procedure may be used while a connection with another BLE device is formed in a BLE piconet.

If a scanning device receives a broadcasted advertising event and is in an initiator mode in which it can initiate a connection request, the scanning device may start a Bluetooth connection with an advertising device by transmitting a connection request to the advertising device through an advertising physical channel.

If a scanning device transmits a connection request to an advertising device, the scanning device stops initiator mode scanning for an additional broadcast and enters a connected mode.

Discovering Procedure

Devices capable of Bluetooth communication (hereinafter Bluetooth devices) perform an advertising procedure and scanning procedure in order to discover devices present nearby or in order to be discovered by other devices within a given area.

A discovering procedure is asymmetrically performed. A Bluetooth device that tries to discover surrounding other devices is called a discovering device, and listens to discover devices that advertise a scannable advertising event. A Bluetooth device that is discovered from another device and that is available is called a discoverable device, and broadcasts an advertising event so that it is actively scanned by another device through an advertising (broadcast) physical channel.

Both a discovering device and a discoverable device may have already been connected with other Bluetooth devices in a piconet.

Connecting Procedure

A connecting procedure is asymmetrical, and a connecting procedure requires another Bluetooth device to perform a scanning procedure while a specific Bluetooth device performs an advertising procedure.

That is, an advertising procedure may become an object. As a result, only one device may respond to advertising. After a connectable advertising event is received from an advertising device, a connection may be initiated by transmitting a connection request to the advertising device through an advertising (broadcast) physical channel.

Hereinafter, operating states in BLE technology, that is, an advertising state, a scanning state, an initiating state, and a connection state are described in brief

Advertising State

The link layer (LL) enters an advertising state in response to an instruction from the host (stack). If the link layer is the advertising state, the link layer transmits advertising Packet Data Units (PDUs) in advertising events.

Each of the advertising events is configured with one or more advertising PDUs. The advertising PDUs are transmitted through advertising channel indices used. The advertising events may be terminated a little earlier if they are transmitted through respective advertising channel indices in which the advertising PDUs are sued or if a terminated or advertising device needs to secure a space for performing another function.

Scanning State

The link layer enters a scanning state in response to an instruction from the host (stack).

In the scanning state, the link layer listens to advertising channel indices.

The scanning state includes two types of passive scanning and active scanning. Each of the scanning types is determined by the host.

A separate time or advertising channel index for performing scanning is not defined.

During the scanning state, the link layer listens to an advertising channel index for scan window (scanWindow) duration. A scan interval (scanInterval) is defined as an interval between the starting points of two consecutive scan windows.

If a collision of scheduling is not present, the link layer needs to listen in order to complete all the scan intervals of a scan window as indicated by the host. In each scan window, the link layer needs to scan another advertising channel index. The link layer uses all advertising channel indices as much as possible.

Upon performing passive scanning, the link layer receives only packets and does not transmit any packet.

Upon performing active scanning, the link layer performs listening in order to depend on an advertising PDU type in which advertising PDUs and advertising device-related additional information can be requested from an advertising device.

Initiating State

The link layer enters the initiating state in response to an instruction from the host (stack). When the link layer is in the initiating state, the link layer performs listening on advertising channel indices.

During the initiating state, the link layer listens to an advertising channel index for scan window duration.

Connection State

The link layer enters the connection state when a device performing a connection request, that is, an initiating device, transmits a CONNECT_REQ PDU to an advertising device or when an advertising device receives a CONNECT_REQ PDU from an initiating device.

After the link layer enters the connection state, the generation of a connection is considered. In this case, it does not need to consider that the connection is established at timing when the link layer enters the connection state. A sole difference between a newly formed connection and an already established connection is only a link layer connection supervision timeout value.

When the two devices are connected, the two devices behave as other roles.

A link layer that performs a master role is called a master, and a link layer that performs a slave role is called a slave. The master adjust the timing of a connection event, and a connection event refers to timing synchronized between the master and the slave.

Hereinafter, packets defined in a Bluetooth interface are described in brief.

BLE devices use packets defined below.

Packet Format

The link layer has only one packet format used for both an advertising channel packet and a data channel packet.

Each of the packets is configured with the four fields of a preamble, an access address, a PDU and CRC.

When one packet is transmitted in an advertising physical channel, a PDU may become an advertising channel PDU. When one packet is transmitted in a data physical channel, a PDU may become a data channel PDU.

Advertising Channel PDU

An advertising channel Packet Data Unit (PDU) has a 16-bit header and payload having various sizes.

The PDU type field of the advertising channel PDU included in the header indicates PDU types, such as those defined in Table 1.

TABLE 1

| PDU Type | Packet Name |
|---|---|
| 0000 | ADV-IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are called advertising PDUs and are used for a detailed event.

ADV_IND: a connectable non-directional advertising event

ADV_DIRECT_IND: a connectable directional advertising event

ADV_NONCONN_IND: a non-connectable non-directional advertising event

ADV_SCAN_IND: a scannable non-directional advertising event

The PDUs are transmitted in the link layer in the advertising state, and are received by the link layer in the scanning state or the initiating state.

Scanning PDUs

The following advertising channel PDU type are called scanning PDUs and are used in the following states.

SCAN_REQ: this is transmitted by the link layer in the scanning state and is received by the link layer in the advertising state.

SCAN_RSP: this is transmitted by the link layer in the advertising state and is received by the link layer in the scanning state.

Initiating PDUs

The following advertising channel PDU type is called an initiating PDU.

CONNECT_REQ: this is transmitted by the link layer in the initiating state and is received by the link layer in the advertising state.

Data Channel PDU

A data channel PDU has a 16-bit header and payload having various sizes, and may include a message integrity check (MIC) field.

The procedures, states, packet format described above in the BLE technology may be applied to perform methods proposed in the disclosure.

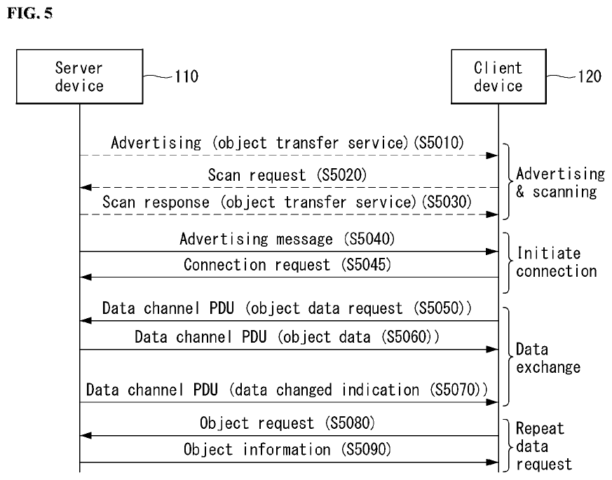

FIG. 5 shows an example of a method of providing an object transfer service in a Bluetooth low energy technology to which the disclosure is applied.

The object transfer service (or object delivery service) refers to a service supported in BLE in order to transmit or receive an object or data, such as bulk data, in Bluetooth communication.

For Bluetooth connection setup between a server device and a client device, an advertising process and a scanning process corresponding to steps S510˜S530 are performed.

First, the server device transmits, to the client device, an advertising message in order to notify server device-related information including an object transfer service (S5010). The advertising message may be represented as an advertising Packet Data Unit (PDU), an advertising packet, advertising, an advertising frame or an advertising physical channel PDU.

The advertising message may include service information (including a service name) provided by the server device, the name of the server device, manufacturer data, etc.

Furthermore, the advertising message may be transmitted to the client device in a broadcast manner or a unicast manner.

Thereafter, the client device transmits a scan request message to the server device in order to be aware of more detailed information related to the server device (S5020).

The scan request message may be represented as a scanning PDU, a scan request PDU, a scan request, a scan request frame or a scan request packet.

Thereafter, the server device transmits a scan response message to the client device as a response to the scan request message received from the client device (S5030).

The scan response message includes the server device-related information requested by the client device. In this case, the server device-related information may be an object or data which may be transmitted by the server device in relation to the provision of the object transfer service.

If the advertising process and scanning process are terminated, the server device and the client device perform an initiating connection process and a data exchange process corresponding to steps S5040˜S5070.

In this case, an advertising message is transmitted to the client device again between the advertising and scanning process and the initiating connection process (S5040).

That is, a connection request is transmitted from the client device to the server device as a response to the advertising message.

Furthermore, the connection request may be transmitted to the server device only when an ADV_IND message and an ADV_DIRECT_IND message are received.

Specifically, the client device transmits a connection request message to the server device for a Bluetooth communication connection with the server device (S5045).

The connection request message may be represented as a connection request PDU, an initiation PDU, a connection request frame or a connection request.

Through step S5045, a Bluetooth connection is established between the server device and the client device. Thereafter, the server device and the client device exchange data. In the data exchange process, the data may be transmitted and received through a data channel PDU.

The client device transmits an object data request to the server device through a data channel PDU (S5050). The data channel PDU may be represented as a data request message or a data request frame.

Thereafter, the server device transmits, to the client device, object data requested by the client device through the data channel PDU (S5060).

In this case, the object data may be an object itself or object metadata.

If the object data is an object itself, the object data is transmitted to the client device through a new L2CAP channel (within a data channel).

Furthermore, if the object data is object metadata, the object data is transmitted to the client device through an L2CAP channel corresponding to a fixed L2CAP channel ID of the ATT Protocol.

In this case, if the object itself is transmitted to the client device, it may be transmitted through the L2CAP.

In this case, the data channel PDU is used to provide data to a peer device or to request data information from a peer device in a way defined in the Attribute protocol.

Thereafter, if a change of data occurs in the server device, the server device transmits Data Changed Indication information to the client device through a data channel PDU in order to notify a change in the data or object (S5070).

Thereafter, the client device requests changed object information from the server device in order to discover changed data or a changed object (S5080).

Thereafter, the server device transmits, to the client device, the object information changed in the server device as a response to the changed object information request (S5090).

Thereafter, the client device discovers the changed object through a comparison and analysis between the received changed object information and object information now owned by the client device.

In this case, the client device repeatedly performs steps S5080 to S5090 until it discovers the changed object or data.

As described above, there is no detailed method of directly notifying, by the server device, the client device of which data has been changed and of notifying, by the server device, the client device of whether new data has been generated.

Furthermore, the server device and the client device consume a lot of time and power because they repeatedly perform steps S5080 to S5090 until they find the changed object or data.

In FIG. 5, it has been described that the server device notifies that (1) the object transfer service is provided and (2) an object or data has been changed, but the disclosure is not limited thereto and may be identically applied to a case where the client device may notify that the object transfer service is provided and an object or data has been changed in the client device.

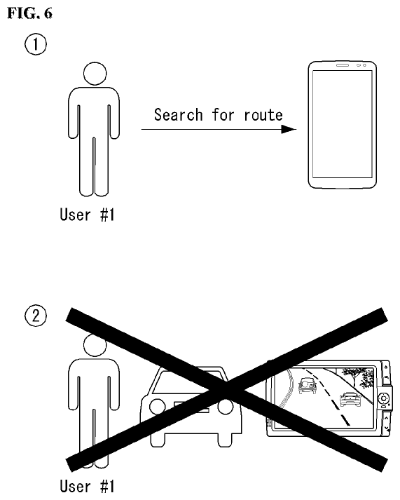

FIG. 6 shows an example of a navigation system.

Referring to FIG. 6, a user sets a route from a source to a destination using the navigation application of a terminal (□), and may move up to the destination along the set route.

However, □ if the user uses a navigation application (e.g., a navigation for a vehicle) not in the latest version state, there is a problem in that the user has to directly update the navigation application with the latest version.

Furthermore, in the case of a navigation for a vehicle, a real-time traffic condition is not incorporated into a set route. That is, there is a problem in that the navigation for a vehicle provides guidance using only the first set route without updating the route by incorporating the real-time traffic condition.

Accordingly, in order to solve such a problem, the disclosure proposes a method of transmitting, to another navigation device, information related to a set route (hereinafter called GPS information) through the navigation application of a terminal and providing a navigation service by incorporating a real-time traffic condition through updated GPS information if the GPS information is updated.

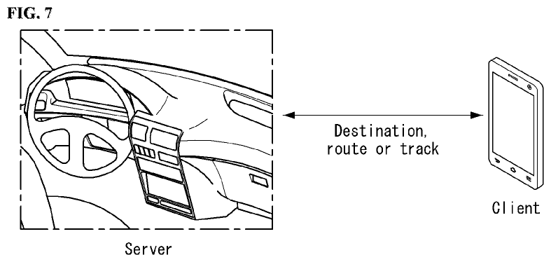

FIG. 7 shows an example of a navigation service proposed in the disclosure.

Referring to FIG. 7, a terminal may show a route by transmitting, to a navigation device, GPS information indicating the route between a source and destination set through a navigation application.

In the disclosure, a profile for providing a navigation service may be referred to as an itinerary sharing profile (ISP).

Specifically, the terminal that performs a client role may transmit and receive information for providing a navigation service to and from the navigation device that performs a server role.

That is, the terminal performing a client role may transmit, to the navigation device performing a server role, GPS information related to a set route through the navigation application.

The GPS information may include at least one of source information, destination information, route information, a waypoint or track information.
Waypoint: this is a series of coordinates for identifying a location and indicates a waypoint in a route from a source to a destination.
Route information: route information indicates a sequence list of way points planned until a destination is reached. Route information may include tens of waypoints. Route information may indicate a travel route from the current location of a user to a destination.
Track information: track information indicates sequence lists of substantially reached waypoints. That is, track information indicates a moved route of a user.
Destination information: the last way point of a route.

A navigation device may provide a navigation service based on GPS information transmitted by a terminal. If GPS information is updated or changed, the navigation device may obtain the updated or changed GPS information from the terminal and incorporate it into a real-time situation.

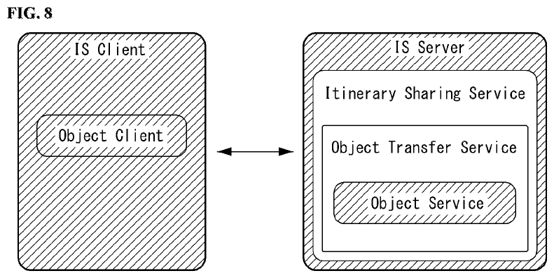

FIG. 8 shows an example of the architecture of a profile proposed in the disclosure.

Referring to FIG. 8, a portion indicated by a slash indicates the role of the profile, and an empty space not including a slash indicates the role of a service.

A navigation service may be used for a client to discover a device that supports the ISP.

A server may instance an object transfer service (OTS) and a navigation service, and may use an object server role defined in the OTS.

Furthermore, the server may perform an interaction with a client for the reading or writing of a destination, a route and a track in order to provide a navigation service.

A client may use an object client role defined in the OTP, and is a device that initiates read, write and related operations performed by the server.

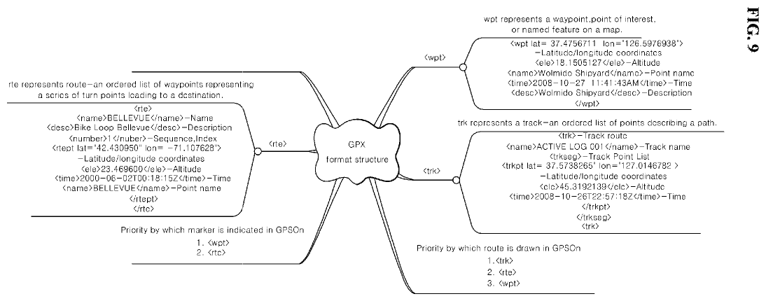

FIG. 9 shows an example of a packet format for providing a navigation service proposed in the disclosure.

Referring to FIG. 9, GPS information, including at least one of source information, destination information, route information, waypoint or track information for providing the navigation service described in FIGS. 7 and 8, may be transmitted and received in the format of a GPS Exchange Format (GPX) form.

In FIG. 9, rte indicates route information, and may include a name, a route description, a sequence, an index, a latitude for indicating the route, the coordinates of the latitude, altitude, time, a point name, etc.

wpt indicates a waypoint, and may include a latitude for indicating a waypoint, the coordinates of the latitude, an altitude, the name of the waypoint, time, a description of the waypoint, etc.

trk indicates track information, and may include a track name, a track point list indicating lists of points of a route along which a user has moved, a latitude for indicating a track, the coordinates of the latitude, an altitude, and time.

The priority of a marker output to a navigation device is higher in wpt than in rte, and a route is output based on the priorities of trk, rte, and wpt.

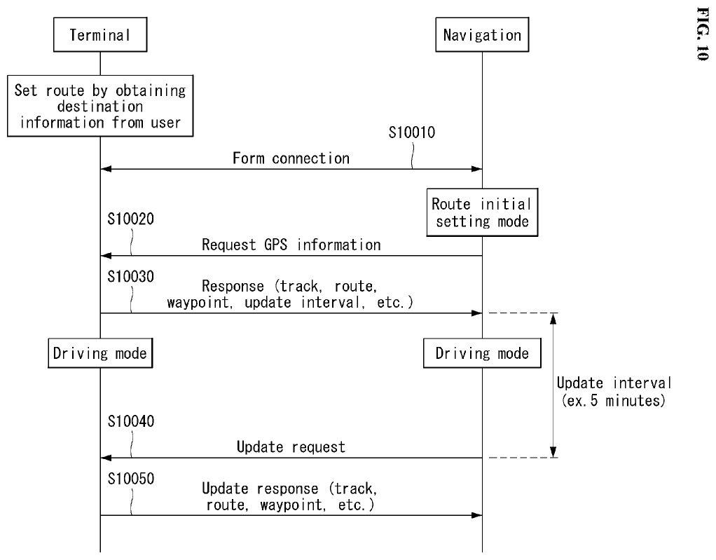

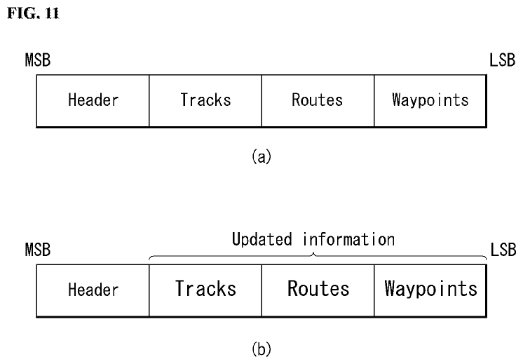

FIGS. 10 and 11 show examples of a method for providing a navigation service, which is proposed in the disclosure.

Referring to FIGS. 10 and 11, a terminal may provide a navigation service by transmitting, to a navigation, GPS information indicating a set route and a changed route at given intervals.

Specifically, the terminal may obtain destination information and source information by obtaining them from a user.

In this case, the source information may be obtained by recognizing the current location of the user through a GPS although it is not received from the user.

The terminal may set a route to a destination based on the obtained source information and destination information.

The terminal may form a connection with the navigation device through Bluetooth LE in order to provide a navigation service (S10010).

In this case, the connection between the terminal and the navigation device may be formed before the terminal obtains the destination information or before or after it sets the route.

For example, the terminal and the navigation device installed in a vehicle may form a connection through Bluetooth LE when a user gets on the vehicle and starts an engine.

After the connection between the terminal and the navigation is formed, the navigation device becomes a Route Initial Setting Mode in order to set an initial route, and transmits, to the terminal, a request message to request GPS information for providing a navigation service (S10020).

That is, the navigation device may request whether to set the route for providing the navigation service by transmitting the request message to the terminal.

The terminal that has received the request for the GPS information related to the set route from the navigation device may transmit, to the navigation, a response message including the GPS information indicating the set route (S10030).

The response message may have a PDU format, such as that of FIG. 11(a). As described in FIGS. 7 and 8, the response message may include at least one of source information, destination information, route information, a waypoint, an update interval (or update cycle) or track information.

Furthermore, the response message may have a format, such as the GPX described in FIG. 9.

The update cycle indicates an interval at which the terminal updates a set route, and may be preset by a user.

The navigation may provide the navigation service based on the GPS information received from the terminal.

Thereafter, the terminal and the navigation device become a driving mode, and may update the GPS information in the update cycle in order to show the best route.

Specifically, after receiving the response message, the navigation transmits, to the terminal, an update request message to request the update of the GPS information at the update interval (S10040).

When the update request message is received from the navigation, the terminal updates the GPS information by incorporating a current traffic condition and/or a surrounding condition.

If the GPS information is not changed, the terminal neglects the update request message of the navigation.

However, if the GPS information has been changed due to a current traffic condition and/or a surrounding condition, the terminal transmits, to the navigation, an update response message including the changed GPS information (S10050). The navigation device may provide a navigation service based on the changed GPS information.

The update response message may have a PDU format, such as that of FIG. 11(b), and may include the updated GPS information.

That is, the update response message may include at least one of updated route information, a waypoint, or track information.

Furthermore, the update response message may have a format, such as the GPX described in FIG. 9 like the response message.

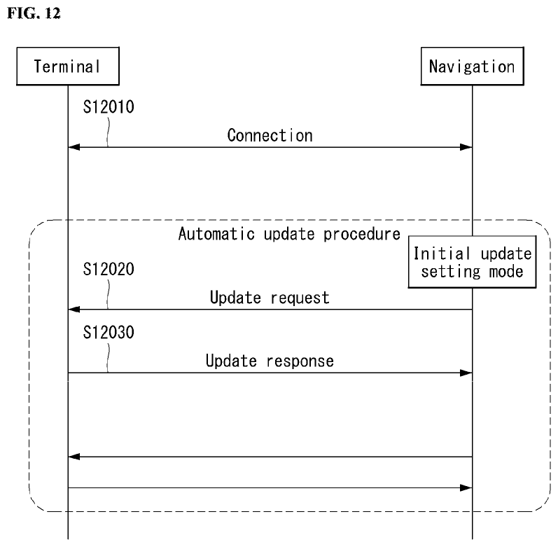

FIG. 12 shows an example of an initial setting method for providing a navigation service, which is proposed in the disclosure.

Referring to FIG. 12, a terminal and a navigation device may update changed information of a map through an initial setting procedure (or automatic update procedure), and may provide a configured specific service.

Specifically, the terminal may form a connection with the navigation device through Bluetooth LE in order to provide a navigation service (S12010).

After forming the connection with the terminal, the navigation device becomes an initial update setting mode, and may update a navigation application and/or map information through an automatic update procedure.

For example, the terminal and the navigation device may update the version of a navigation application, a new road in a map, speed camera information, speed bump information and a fee.

Specifically, the navigation device may transmit, to the terminal, an update request message to request updated information in the initial update setting mode (S12020).

If a navigation application has been updated or information of a map has been updated, the terminal transmits, to the navigation device, an update response message including the updated application information and/or the updated map information (S12030).

The navigation device may update the navigation application and/or the map based on the updated application information and/or the updated map information received from the terminal.

Furthermore, after the connection with the navigation device is formed, the terminal may perform an operation for providing another specific service, such as a navigation service.

In this case, the specific service may be preset by a user or may be a service related to a navigation service.

For example, if a user sets an audio streaming service or a vehicle state information provision service to be executed along with a navigation service, the terminal and the navigation device may form a connection and then operate to provide the audio streaming service or vehicle state information provision service set along with a navigation service.

Through such a method, the application and map information of a navigation device can be updated, and another service can be provided along with a navigation service.

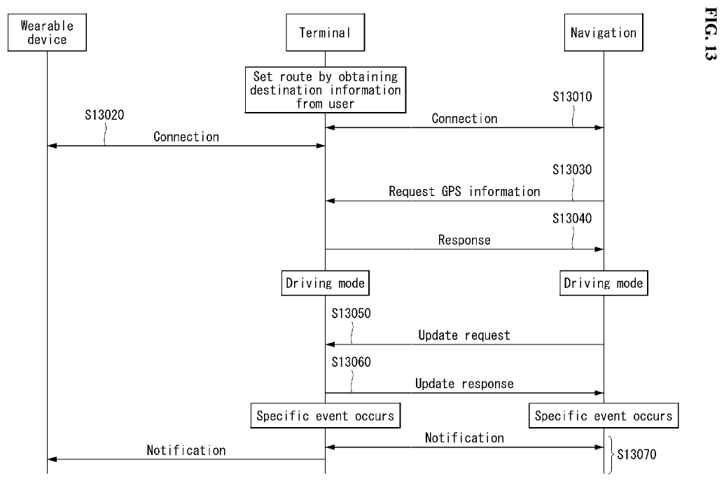

FIG. 13 shows another example of a method for providing a navigation service, which is proposed in the disclosure.

Referring to FIG. 13, if a specific event occurs while a navigation service is provided, a terminal or a navigation device may notify a user of the occurred specific event by transmitting the occurred specific event to a wearable device owned by the user.

Specifically, the terminal may obtain destination information and source information by receiving them from the user.

In this case, the source information may be obtained by recognizing the current location of the user through a GPS although it is not received from the user.

The terminal may set a route to a destination based on the obtained source information and destination information.

The terminal may form a connection with the navigation device through Bluetooth LE in order to provide a navigation service (S13010).

In this case, the connection between the terminal and the navigation device may be formed before the terminal obtains the destination information or before or after it sets the route.

For example, the terminal and the navigation device installed in a vehicle may form a connection through Bluetooth LE when a user gets on the vehicle and starts an engine.

Furthermore, the terminal may form a connection with a wearable device owned by the user or attached to the user through Bluetooth LE.

Thereafter, steps S13030 to 13060 are the same as steps S10020 to S10050 of FIG. 10, and thus a description thereof is omitted.

If a specific event occurs while the navigation service is provided, the terminal may notify the navigation device and the wearable device of the occurrence of the specific event by transmitting, to the navigation device and the wearable device, a notification message indicating the specific event (S13070).

The navigation device and the wearable device that have received the notification message from the terminal may perform different outputs depending on the type of specific event in order to notify the user of the specific event.

For example, in the case of a time zone in which sleepiness occurs, the wearable device and/or the navigation device may notify a user of a time zone in which sleepiness occurs by outputting a specific alarm or vibration.

Table 2 below is a table showing examples of specific events.

TABLE 2

| Name | Description |
|---|---|
| Direction Notification | Notify (Left, Right) when a |
| | direction change is necessary |
| Danger Notification | Notify upon danger area and |
| | dangerous situation |
| Sleepiness Notification | Notify when a sleepiness time |
| | zone and sleepiness is detected |
| Speed Bump Notification | Notify a speed bump |
| Blind Spot Detection (BSD) | Notify BSD |
| Notification | |

The specific event may include various events occurring while driving, for providing an alarm to a user, in addition to the events shown in Table 2.

Furthermore, if a specific event occurs, the navigation device may also transmit a notification message to the terminal in order to notify the terminal of the specific event. The terminal may notify the wearable device of the specific event.

Through such a method, if a specific event occurs, the terminal and/or the navigation device notify the wearable device worn by a user of the occurred specific event. Accordingly, the user can immediately recognize the occurred specific event.

Furthermore, as another embodiment of the disclosure, the wearable device may sense body information or a body state of a user, and may transmit the sensed body information or body state to the terminal and/or the navigation device.

The terminal and/or the navigation device may perform a specific operation based on the received body information or body state.

For example, if a user dozes, the wearable device may transmit, to the terminal and/or the navigation device, body information or a body state indicating the drowsiness.

The terminal and/or the navigation device can recognize that the user dozes while driving based on the body information or body state received from the wearable device, and may output an alarm in order to wake the user up.

Alternatively, if a user is placed in an urgent situation (e.g., cardiac arrest or faint) while driving, the wearable device may transmit, to the terminal and/or the navigation device, body information or a body state indicating the urgent situation.

The terminal and/or the navigation device can recognize that the user is in the urgent situation based on the body information or body state received from the wearable device, and can prevent an accident by transmitting the urgent situation to a surrounding emergency center or structure facility.

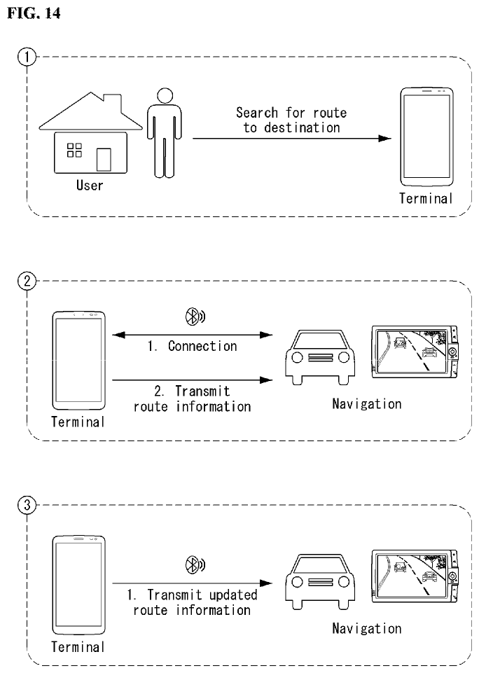

FIG. 14 shows another example of a method for providing a navigation service, which is proposed in the disclosure.

Referring to FIG. 14, □ a user may set a route through pre-search through the navigation application of a terminal in order to find out a route and time from a home to a Busan Station, that is, a destination.
After the route to the destination is set through the search, the user may activate Bluetooth of the terminal on his or her way to a parking lot, and gets on a vehicle. 1. The navigation device of the vehicle and the terminal have been previously connected through an initial connection. When the vehicle is started, the navigation device of the vehicle and the terminal may be automatically connected.

2. When the vehicle and the terminal are connected through Bluetooth, the terminal transmits, to the navigation device, GPS information for providing a navigation service through the route set through the search.
If the route to the destination needs to be updated because a traffic condition is changed in real time while the vehicle travels, the terminal may transmit updated GPS information to the navigation device in an update cycle transmitted along with the GPS information.

In this case, the navigation device may transmit an update request message to the terminal in order to request the updated GPS information.

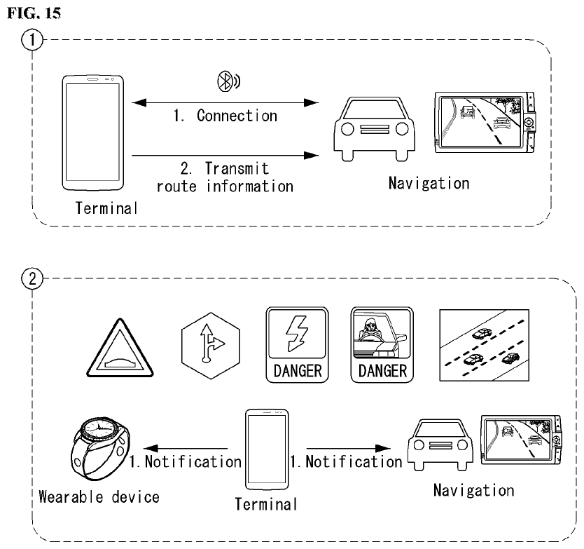

FIG. 15 shows another example of a method for providing a navigation service, which is proposed in the disclosure.

Referring to FIG. 15, □ a terminal may transmit, to the navigation device of a vehicle, GPS information indicating a route to a destination through the method described in FIGS. 10 to 14.
When a specific event occurs while the vehicle travels (e.g., a direction change, a danger area or a warning of dozing-off while driving), the terminal may notify devices (e.g., navigation device and wearable device) connected to the terminal of the occurred specific event by transmitting a notification message to the devices.

The devices that have recognize the occurrence of the specific event through the notification message received from the terminal may notify a user of the occurred specific event through a specific output.

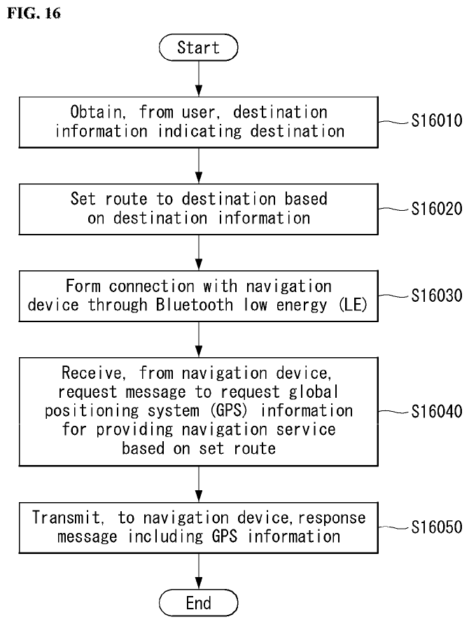

FIG. 16 is a flowchart illustrating an example of a method for providing a navigation service, which is proposed in the disclosure.

Referring to FIG. 16, a terminal obtains, from a user, destination information indicating a destination (S16010). Furthermore, the terminal may obtain source information by recognizing the current location of the user using a GPS or may receive the source information from the user.

The terminal may set a route to the destination based on the source information and/or the destination information, and may form a connection with the navigation device of a vehicle through Bluetooth LE (S16020).

Thereafter, the terminal may receive, from the navigation device, a request message to request global positioning system (GPS) information for providing a navigation service based on the set route (S16040).

After receiving the request message from the navigation device, the terminal may transmit, to the navigation device, a response message including the GPS information related to the set route to the destination (S16050).

In this case, the GPS information may include at least one of the source information, the destination information, route information, a waypoint, an update interval (or update cycle) or track information as described in FIGS. 10 to 14.

Furthermore, the GPS information may have a GPX format structure.

Thereafter, the terminal and the navigation device may perform the GPS information update procedure described in steps S10040 and S10050 of FIG. 10. If a specific event occurs, the terminal and the navigation device may perform the procedure described in step S13070 of FIG. 13.

The aforementioned disclosure is not limitedly applied to the elements and methods of the aforementioned embodiments, and some of or all the embodiments may be selectively combined and configured so that the embodiments can be modified in various manners.

Furthermore, the disclosure described above may be substituted, modified and changed in various ways by a person having ordinary skill in the art to which the present disclosure pertains without departing from the technical spirit of the present disclosure, and thus the disclosure is not restricted by the aforementioned embodiments and the accompanying drawings.

### INDUSTRIAL APPLICABILITY

The disclosure relates to Bluetooth data transmission and reception and, more particularly, to a method and apparatus for providing a service through wireless communication means using the Bluetooth low energy (LE) technology.

1. A method of setting, by a terminal, a route along with a navigation device in a wireless communication system, the method comprising:
obtaining, from a user, destination information indicating a destination;
setting a route to the destination based on the destination information;
forming a connection with the navigation device through Bluetooth low energy (LE);
receiving, from the navigation device, a request message to request global positioning system (GPS) information for providing a navigation service based on the set route; and
transmitting, to the navigation device, a response message comprising the GPS information.

2. The method of claim 1,
wherein the GPS information comprises at least one of route information indicating a travel route to the destination, track information indicating a moved route of the user or way point information indicating a waypoint between routes from a source to the destination, and
wherein a format of the GPS information is a GPS exchange format (GPX).

3. The method of claim 1, further comprising:
receiving, from the navigation device, an update request message to request GPS information changed in a specific cycle; and
transmitting, to the navigation device, an update response message comprising the changed GPS information if the GPS information is changed.

4. The method of claim 1, further comprising:
forming a connection with a wearable device through Bluetooth low energy (LE); and
transmitting a notification message for a notification of a specific event to at least one of the wearable device or the navigation device when the specific event occurs while providing the navigation service.

5. The method of claim 4, further comprising:
obtaining, from the wearable device, state information indicating a body state of the user; and
transmitting, to at least one of the wearable device or the navigation device, an indication message indicating a specific operation based on the body state.

6. The method of claim 1, further comprising:
performing an initial update procedure for providing the navigation service along with the navigation device.

7. The method of claim 6,
wherein the initial update procedure comprises:
receiving an update request message to request an update of map information for providing the navigation service; and
transmitting an update response message comprising the updated map information if the map information is updated.

8. The method of claim 7,
wherein the initial update procedure further comprises performing an operation for providing a specific service configured to be executed with the navigation service.

9. A terminal for setting a route along with a navigation device in a wireless communication system, the terminal comprising:
a communication unit for performing wireless or wired communication with an outside; and
a processor functionally connected to the communication unit,
wherein the processor is configured to:
obtain, from a user, destination information indicating a destination;
set a route to the destination based on the destination information;
form a connection with the navigation device through Bluetooth low energy (LE);
receive, from the navigation device, a request message to request global positioning system (GPS) information for providing a navigation service based on the set route; and
transmit, to the navigation device, a response message comprising the GPS information.

10. The terminal of claim 8,
wherein the GPS information comprises at least one of route information indicating a travel route to the destination, track information indicating a moved route of the user or way point information indicating a waypoint between routes from a source to the destination, and
wherein a format of the GPS information is a GPS exchange format (GPX).

11. The terminal of claim 9,
wherein the processor is configured to:
receive, from the navigation device, an update request message to request GPS information changed in a specific cycle; and
transmit, to the navigation device, an update response message comprising the changed GPS information if the GPS information is changed.

12. The terminal of claim 9,
wherein the processor is configured to:
form a connection with a wearable device through Bluetooth low energy (LE); and
transmit a notification message for a notification of a specific event to at least one of the wearable device or the navigation device when the specific event occurs while providing the navigation service.

13. The terminal of claim 12,
wherein the processor is configured to:
obtain, from the wearable device, state information indicating a body state of the user; and
transmit, to at least one of the wearable device or the navigation device, an indication message indicating a specific operation based on the body state.

14. The terminal of claim 9,
wherein the processor is configured to perform an initial update procedure for providing the navigation service along with the navigation device.

15. The terminal of claim 14,
wherein the processor is configured to:
receive an update request message to request an update of map information for providing the navigation service; and
transmit an update response message comprising the updated map information if the map information is updated.

16. The terminal of claim 15,
wherein the processor is configured to perform an operation for providing a specific service configured to be executed with the navigation service.
